(19) United States
(12) Patent Application Publication
(10) Pub. No.: US 2021/0310292 A1
(43) Pub. Date: Oct. 7, 2021

(54) FURNITURE COMPONENT AND METHOD OF MANUFACTURING

(71) Applicant: AMBIGENCE GMBH & CO. KG, Herford (DE)

(72) Inventors: Michael TASCHE, Bielefeld (DE); Gerhard GÖTZ, Bünde (DE); Uwe SOBOLEWSKI, Bünde (DE); Stefan DIETRICH, Herford (DE); Michael SCHUBERT, Coburg (DE)

(21) Appl. No.: 17/269,485

(22) PCT Filed: Aug. 22, 2019
(86) PCT No.: PCT/EP2019/072496

§ 371 Date: Feb. 18, 2021

(30) Foreign Application Priority Data
Aug. 23, 2018 (DE) 10 2018 120 661.5

(51) Int. Cl. E05D 15/58; E05D 15/40; E05F 1/10; E05F 15/70; E05D 15/16; E05F 5/06

(52) U.S. Cl. CPC E05D 15/58; E05D 15/406; E05F 1/1058; E05Y 2900/20; E05D 15/165; E05F 5/06; E05F 1/1091; E05F 15/70

(57) ABSTRACT

A furniture component and method of manufacturing the same, the furniture component having a wall with at least two opposite side faces and a multitude of front faces. On the wall between the side faces, a takeup space is configured which accommodates a set of fittings for guiding a movable furniture element. The set of fittings includes a multitude of fitting components and can be transferred to at least two positions. The takeup space includes aperture sections in at least two front faces of the wall, where the takeup space is outwardly open. The set of fittings is configured and set up such that during transfer of the set of fittings from the first position to the second position, the set of fittings moves at least in the aperture sections in the at least two front faces.

The present invention relates to a furniture component having at least one wall, comprising at least two opposite side faces and a plurality of front faces. On the wall between the side faces, a takeup space is configured in which at least one set of fittings is received for guiding a movable furniture element.

The prior art has disclosed a great variety of furniture, and in particular kitchen furniture such as base cabinets or wall cabinets, which as a rule show an open-front furniture carcass, to which movable furniture elements are mounted which are guided by means of fittings. The movably guided furniture elements may in particular be drawers showing a drawer front panel, or doors or flap doors, which may be installed in a furniture carcass separately or in various combinations. The present invention relates in particular to employing doors and flap doors and lids as movable furniture elements. In the scope of the present application, doors and flap doors are differentiated by way of the orientation of their pivot axes, which in the case of doors is as a rule vertical, and in the case of flap doors tends to be horizontal. Most pivoting lids also show a horizontally oriented pivot axis. However, doors, flap doors and lids cannot only be opened by a pivoting motion, but also by linear motions or combined linear and pivoting motions.

In all the cases, the doors, lids and flap doors may be one-piece or consist of multiple, interconnected components moving relative to one another in a sequence of motions.

As a rule, door hinges are used for door guides, which are pivotally disposed on the side between the furniture carcass and the door. A similar hinge configuration may basically be used for flap doors as well. These hinges are disposed along an upper side edge of the flap door. However, users often wish to open flap doors in a combined pivoting and sliding motion, for example in the case of a wall cabinet, to gain the largest possible access to the cabinet interior, without having to pivot the flap door to a horizontal position, in which users may have problems with reaching it for closing. For this reason, special flap door fittings have been developed for placement not along the pivot axis between the furniture carcass and the flap door but laterally, often on both lateral edges between the flap door and the sidewall of the furniture carcass.

These kinds of door hinges or flap door fittings are known, for mounting to an inside surface of the sidewall. It is inevitable though for the fittings to protrude into the interior of the furniture carcass, so that for one, they reduce the useful storage space inside the furniture carcass, and for another, they restrict the layout options for the interior of the furniture carcass. The mounted fittings likewise inhibit cleaning the interior, in particular the inside surface of the sidewall of the furniture carcass. For optical appearance reasons, sidewalls without any fittings are desirable as well.

For mounting door hinges it is known to mill-cut a pocket into the front face of a sidewall in which the door hinge can be inserted from the front. The inside surface of the sidewall is thus kept clear. A hinge suitable for insertion into such a mill-cut pocket is for example known from the document DE 1 559 963 A. This operation is, however, suitable only for door hinges showing a very shallow mounting depth. This is due to the limited milling depth which is feasible, for economic reasons in the production process, for such a pocket to be mill-cut in the sidewall from the front face. The mounting thickness of the door hinge inserted into such mill-cut pockets is very limited as well, since in the field of furniture, side walls show wall thicknesses of no more than circa 16-20 mm (millimeters). In mill-cutting, a certain minimum wall thickness must remain to the sides of the milled-out pockets, since too thin walls would tear or break already during mill-cutting, or they would be deformed such that their surfaces appear less than flawless.

Thus, using large and complex door hinges is already impossible. As a rule, flap door hinges show a large mounting depth in the range of more than 10 or 15 cm (centimeters), which cannot be obtained by way of mill-cutting from the front face.

WO 2017/029 199 A1 discloses a kitchen wall cabinet with a block-shaped cabinet carcass, whose open-front face can be closed by a cabinet door configured as a flap door. The inside surfaces of the side walls show tilt gear for the flap door, attached in the top region of the cabinet carcass. The tilt gear is covered inwardly by separate inner walls. This leads to a very wide structure of the lateral walls. The interior of the cabinet carcass may be provided with a number of shelf sections on top of one another. The bottommost shelf section is always open, independently of the opened or closed position of the flap door, and accessible for setting down or parking kitchen utensils. The flap door comprises an interior board, and an exterior board that reaches further downwardly and is attached to the outside of the interior board. This causes the exterior board to protrude outwardly and enables ease of gripping the flap door. This document ensures permanent access to the bottommost shelf section. However, there is the drawback of a smaller inner space due to the thick wall structure. Moreover, a uniform outside surface cannot be provided since part of the interior is intended to be continuously accessible, independently of the open or closed position of the flap door, and since part of the flap door protrudes outwardly.

The document DE 20 2013 003 189 U1 discloses a sidewall for a furniture carcass, wherein the sidewall consists of different parts in some sections. In particular a rear part facing away from the cabinet front face is configured conventionally, for example by a coated wood element. In the document indicated, a front part of the sidewall is formed by a housing not described in detail, comprising a front aperture into which fittings can be pushed. The housing is connected with the conventional portion of the sidewall, for example by means of dowel pins or screws. Since the housing may be provided with housing walls thinner than can be achieved by milling and also enables increased mounting depths, this housing may be used for accommodating large door hinges or flap door fittings. The surface appearance and haptics of the housing will, however, as a rule not correspond precisely to that of the conventional part of the sidewall so that uniformity of the sidewall surface cannot be achieved. Moreover, the transition between the two housing parts will be visible and optionally also sensible.

The document DE 10 2015 108 694 A1 describes a furniture carcass, with an upwardly pivoting flap door, guided by hinges disposed along the top side edge of the flap door. Moreover, a supporting device for the flap door is provided for supporting the weight of the flap door in the (partially) opened state. The supporting device is inserted in a housing configured as a profile and forming the front part of the sidewall. The profile extends over the entire height of the sidewall. Inside the profile, sliding guides for sliding shoes are configured, which are part of the counterweight. By way of a tongue and groove joint, the profile is connected with a core of the sidewall, which is manufactured from a wood material, on the front face of the sidewall with the aid of adhesives. On the outside, the sidewall is provided with a uniform covering layer in the region of the core. Another covering layer is applied on the core toward the interior of the furniture carcass. The fitting system shown is thus a normal sidewall, in which the joiner must mill-cut a groove on the front face, for mounting the counterweight to the sidewall.

A uniform surface appearance and haptics are not obtained since the sidewall fittings show a spoiling, visual face. Also, the layout options of the interior are restricted.

In known wall cabinets provided with pivot-mounted flap doors, another drawback is that full access to the interior of such a furniture carcass is often not possible. When the flap door pivots along the top side edge, users may find the opened flap door out of reach. With other pivoting motions, for example the handle on the flap door may be in an inconvenient position if access to large areas of the interior is enabled.

It is therefore the object of the present invention to provide a furniture component and a method of manufacturing a furniture component, wherein a wall of the furniture component may accommodate large sets of fittings, and wherein a movable furniture element is guided such that a large cross section can be cleared.

This object is solved by a furniture component having the features of claim 1 and by a method having the features of claim 23. Preferred specific embodiments of the invention are the subjects of the subclaims. Further advantages and features of the present invention can be taken from the general description and the description of the exemplary embodiments.

A furniture component according to the invention comprises at least one wall, wherein the wall comprises at least two opposite side faces and a plurality of front faces. On the wall between the side faces, a takeup space is configured in which a set of fittings for guiding a movable furniture element is received. The set of fittings comprises a plurality of fitting components and (in the mounted or operational state relative to the wall) can be moved to at least two positions. At least two front faces (i.e. a first and at least one second front face) of the wall show aperture sections in the takeup space where the takeup space is outwardly open. The set of fittings is configured and set up such that, during transfer of the set of fittings from the first position to the second position, the set of fittings moves at least in the two aperture sections on the two or more front faces.

The furniture component according to the invention has many advantages. A considerable advantage of the furniture component according to the invention consists in the fact that at least two of the front wall faces are provided with aperture sections, in which the set of fittings respectively at least parts of the set of fittings can move. This does not only enable ease of pivoting motions, for example of a flap door along the front face of a furniture component, but the entire set of fittings or parts of the set of fittings can, during transfer from the first position to the second position, move at least in the two aperture sections.

A furniture component wall accommodating sets of fittings may also be referred to as a functional wall. The term “wall” may be replaced by the term “functional wall”, if such a wall accommodates sets of fittings in a takeup space.

The surface of a takeup space adjacent (or parallel) to the side face of the wall is in particular smaller than ¾ of the surface of at least one of the side faces. The size of the surface area of the takeup space adjacent to the side face is in particular less than ⅔ and preferably less than ½ the surface of at least one of the side faces.

The size of the surface area of the takeup space is in particular between 5% and 80%, preferably between 5% and 80%, particularly preferably between 5% and 75% (or between 10% and 75%) of the size of the surface of at least one of the side faces. The surface area of a takeup space is understood to mean the clear surface area of the cross section of the takeup space. The cross section extends adjacent to the side face and in particular parallel to the side face (respectively at least one of the side faces).

The takeup space is formed inside the wall. There is not one, completely serviceable sidewall and separate inner wall spaced apart from one another, between which a hollow space opens up across the surface area of the inner wall. The takeup space is formed inside one single wall unit. The wall unit may consist of one or two or more elements connected with one another in a plane.

The wall thickness of the wall is in particular between 12 mm and 30 mm (or 33 mm) and preferably between circa 13 mm and 27 mm, and particularly preferably between 14 mm and 25 mm. In advantageous configurations the wall thickness of the wall is between 13 mm or 15 mm and 23 mm. The wall thickness is in particular between 16-20 mm (preferably ±10% or ±1 mm).

The set of fittings enters the aperture sections in particular in at least one, and in particular two, of the front faces. Preferably the set of fittings protrudes outwardly at least in sections from at least one, and particularly preferably both, of the aperture sections. This means that the set of fittings is configured and set up so that the set of fittings or at least part of the set of fittings or a fitting component or particular fitting components, move during transfer of the set of fittings from the first position to the second position, at least in the two aperture sections in the at least two front faces. At least one fitting component or multiple fitting components preferably remain/s stationary relative to the wall.

The set of fittings may be configured directly as a fitting (furniture fitting), or it may comprise a fitting and a separate housing in which the fitting can be inserted. The set of fittings may in particular be configured as a flap door fitting or door fitting or a lid fitting.

In simple configurations the furniture component comprises one wall only, or it is configured as a furniture wall unit. Alternately, the furniture component may be part of a piece of furniture or part of a (furniture) carcass. The furniture component may also comprise multiple parts, and it may be configured as a complete piece of furniture. Alternately it is possible for the furniture component to form an entire furniture group, for example a wall cabinet group or a wall cabinet configuration.

Each of the aperture sections is outwardly open. This means that they are open toward the respective front face from where they offer access.

In a preferred specific embodiment the two aperture sections are configured in adjacent front faces. Each of the front faces may extend straight or linearly, enclosing a (an acute or obtuse) corner. In many cases an angle of 90° (±5°) between two adjacent front faces is given. Alternately it is possible for the front faces to join one another in rounded corners. A rounded contour virtually provides a number of front face sections. Then the pertaining front face sections may be considered to be front faces in the sense of the present application. Then, a multitude or plurality of aperture areas slightly angled toward one another (and/or blending into one another) generally form two aperture sections extending transverse to one another in differently oriented front faces.

Preferably the two aperture sections are disposed adjacent to, and blending into, one another. This configuration enables a particularly advantageous embodiment, where a fitting component of the set of fittings passes beneath two aperture sections, and thus moves through the aperture sections on two front faces oriented at angles to one another. This enables, for example in a pivoting motion of a fitting component between the first and second positions, a pivoting angle that is considerably larger compared to an aperture section provided in one front face of the wall only. This allows to achieve a larger opening angle with otherwise substantially identical fitting components.

Alternately it is possible to configure two or more aperture sections remote from one another in two or more front faces, which may not be directly adjacent to one another. Then, advantageous sequences of motions may also be provided which on the whole provide a larger opening cross-section for example of a flap door.

In a specific configuration the two or more aperture sections remote from one another may also be disposed on spaced-apart front faces or front faces of a wall (approximately) opposite to one another. Then, the aperture sections may be configured on opposite front faces only, or at least one aperture section may be given in a front face oriented transverse thereto.

These configurations with aperture sections (also) in spaced-apart front faces or (also) in opposite front faces allow for advantageous motion options. For example when a fitting component moves between the first and second positions and/or an intermediate position, two or multiple movable furniture elements can be moved, such as doors, flap doors, lids or front panels disposed in (front faces of) the wall (approximately) opposite to one another.

In the sense of the present application, disposed opposite is understood to mean that at least two aperture sections are disposed on opposite sides, or at least approximately opposite.

This may occur simultaneously or in a sequence of motions. This principle may be employed for example for traversing an interior tray or an interior carcass of a wall cabinet relative to the wall according to the invention, both downwardly and upwardly, outside the wall extensions.

Preferably the takeup space accommodates a fitting component formed as a hollow profile. Further fitting components may be received on, and in particular in, the fitting component in at least one position. It is possible for one or multiple fitting components to be at least partially outside the hollow profile in at least one position. The hollow profile may in particular be configured as a housing. Alternately it is possible for the hollow profile to show no closed walls. The hollow profile may provide a basic structure or a basic body for the set of fittings to receive a complete fitting. It is also possible for multiple fitting components to be attached to, and/or at least temporarily accommodated in, the hollow profile.

The hollow profile is in particular open toward at least two, and in particular toward precisely two, front faces of the wall.

A hollow profile in the takeup space offers advantages in manufacturing and mounting. A fitting accommodated exchangeably on the hollow profile also facilitates exchanges or repairs.

In a preferred specific embodiment at least one fitting component is taken from a group of fitting components comprising, gearings, lever arms, rotating points, stoppers, damper components, energy storage devices, actuators, sensors, coil springs, pressure accumulators, telescopic track systems, sliding tracks such as plate tracks, central tracks, front panel tracks, installation profiles, attachment members and link guides showing one or more straight or bent link guide sections or linear guides and the like.

Particularly preferably the set of fittings comprises a gearing or at least one gearing. A gearing may be formed for example by a lever mechanism. Alternately it is possible for a gearing to be configured as a linear guide. It is also possible for a gearing to comprise a lever mechanism and at least one linear guide. It is preferred to provide at least one energy storage device. An energy storage device enables for example transferring the movable furniture element from an intermediate position to one or both of the end positions, wherein the direction of bias may depend on the current position.

Particularly preferably the set of fittings comprises at least one lever arm as a fitting component, which during transfer from the first position to the second position passes through both of the aperture sections. A lever arm which for example pivots through both of the aperture sections, enables a particularly large pivoting range and thus a particularly large opening cross-section. Use in a wall cabinet may for example enable nearly 100% free access to the interior, providing the user with unrestricted utilization. The interior of such a wall cabinet is not impaired in opening or closing motions by lever arms or fitting components.

In preferred specific embodiments, the furniture component comprises at least one movable furniture element connected with the set of fittings. The furniture element may be connected with the wall for linear and/or pivotal movement. A furniture element configured for example as a flap door, a lid or door, may be one piece or multipart.

In advantageous specific embodiments the first position is a closed position and the second position, an open position. It is possible and preferred for the set of fittings to assume not only two different positions, but a multitude of positions. The open and closed positions may be the end positions. Alternately it is possible to provide a specific opening angle which defines the open position by way of a grid or the like. Then, a still wider pivoting or opening may be enabled so that the open position is not the end position. Thus, the first and second positions of the invention may be intermediate positions in the entire sequence of motions.

It is preferred for the fitting components to be disposed in the closed position within a wall volume opened up by the front faces and the side faces, other than attachment members for attaching the movable furniture element to the set of fittings. Thus, for example parts for attaching the movable furniture element such as parts of screws (including in the closed position) may protrude into at least one aperture section. It is also possible for a flange and/or a mounting plate or the like to protrude into an aperture section in the closed position. On the whole, however, the set of fittings preferably does not protrude outwardly in the closed position.

Particularly preferably the movable furniture element is disposed on an access side in the closed position, separating a takeup compartment behind the movable furniture element, which is accessible from the access side in the open position. It is also possible for the movable furniture element to separate two or more takeup compartments in the closed position. The movable furniture element can completely close the takeup compartment in the closed position. Alternately it is possible for the takeup compartment or one of the takeup compartments to remain accessible from specific angles or positions, and thus to be just partially separated but not completely closed. For example, access from the side may be feasible while the takeup compartment is closed from the front (or the top).

Particularly preferably one of the aperture sections on the front face is formed on the access side and the other of the aperture sections on the front face, on a longitudinal face extending transverse thereto.

Preferably the aperture section on the access side is configured longer than is the aperture section on the longitudinal face. Particularly preferably the projection of the aperture section on the access side toward the access side is longer than the projection of the aperture section on the longitudinal face toward the longitudinal face. This applies in particular in the case of rounded front faces and aperture sections.

Preferably the aperture section on the access side is at least twice as long or at least three times or at least four times as long as the aperture section on the longitudinal face.

Even given short aperture sections on the longitudinal face, the provided movement range of the movable furniture element may on the whole be considerably increased. As a rule it is not required to configure a long aperture section on the longitudinal face since the two interconnected aperture sections on adjacent front faces already allow a large movement range for the movable furniture element.

In particular the proportion of the length of the aperture section to the length of the front face on the access side is larger than ⅓. Preferably the proportion of the length of the aperture section to the length of the front face on the longitudinal face is less than ⅓.

In preferred implementations it is possible for the aperture section on the access side to extend across the entire height of the wall or nearly the entire height of the wall. The aperture section on the longitudinal face is preferably shorter than the length of the longitudinal face. The aperture section is in particular shorter than half the length or ⅓ the length or ¼ the length of the longitudinal face. The length of the aperture section on the longitudinal face may be as short as ⅙ or ⅛ or 1/10 the length of the aperture section on the longitudinal face.

When the aperture section on the access side does not extend across the entire height of the wall or nearly the entire height of the wall, it is preferably possible for the aperture section on the access side to be considerably shorter than the entire height of the wall. Preferably the length of the aperture section on the access side is between 1/10 and ⅔ of the entire height (or length) of the wall on the access side. In many cases the length of the aperture section on the access side is between ⅕ and ½ of the entire height (or length) of the wall on the access side.

The set of fittings is in particular configured and set up such that during transfer of the set of fittings from the first position to the second position, at least one of the fitting components moves at least in a first aperture section, and that during transfer of the set of fittings from the first position to the second position, one of the fitting components (in particular the same, or another) moves at least in the second aperture section. In transferring the set of fittings from the first position to the second position, in particular the same fitting component moves from inside into the second aperture section, and emerges.

Particularly preferably the set of fittings is configured and set up such that during transfer of the set of fittings from the first position to the second position, at least one of the fitting components moves in the two aperture sections, and at least one of the two aperture sections passes outwardly from the inside.

In all the configurations it is preferred for at least one of the side faces or both of the side faces to be formed on a continuous (and separate) cover layer. It is preferred for at least one of the side faces to be at least partially, or substantially entirely, or entirely, formed by a cover layer. Preferably both of the side faces are substantially entirely, or entirely, covered by, or configured on, a cover layer. It is also possible for the front faces to be at least partially covered by similar or like or optically similar cover layers (in particular completely, except for the aperture sections).

The wall comprises at least one core on which at least part of the takeup space is configured. The takeup space is not formed between two separate, spaced apart walls, but at least partially on at least one core of the wall.

Advantageously the wall comprises at least one core that is in particular plate-shaped. At least one core is preferably connected with the set of fittings. The core may be directly connected with the fitting or with a hollow profile in or to which the further fitting components are received or attached. The set of fittings is preferably provided with at least one installation profile, which is connected with the core in a form-fit and/or force-fit and/or by adhesive bond, to ensure a firm connection. The set of fittings may be connected with the core, other than by a form-fit connection, also by way of clamps, screws or other standard attachment methods.

In preferred configurations the wall comprises at least two cores. Preferably (at least) one recess each is incorporated in exactly two cores or in at least two cores, or in each of the cores. Preferably the cores, or at least two of the cores, are interconnected. The recess and/or the takeup space may also be formed by multiple core portions.

In all the configurations it is alternately possible for multiple core portions to form a recess by way of placement around an intended recess. The recess may form the takeup space, or the takeup space is provided on a component (such as a hollow profile or a housing) positioned in the recess.

In advantageous configurations the set of fittings and/or the core or at least one or two of the cores, is connected with, and for example glued to, at least one of the cover layers.

Preferably at least one takeup compartment is provided on the furniture component, the takeup compartment being bordered by at least one board and/or at least one top board and/or at least one bottom board and at least one wall. The takeup compartment can be at least partially closed by the movable furniture element. In simple configurations a furniture component may comprise one wall only, for example a bottom board and optionally a top board and a flap door. Then the takeup compartment is bordered by the furniture component on one lateral side only. This may even be sufficient for closing the takeup compartment virtually completely, for example if the furniture component is positioned in a corner of a room, and a room wall closes the side of the takeup compartment. In some cases, one wall only may be desired, so as to leave the takeup compartment open on one side. It is likewise possible for the takeup compartment to not be bordered upwardly. Alternately it is possible for the furniture component to comprise multiple takeup compartments and multiple walls, at least one wall accommodating a set of fittings.

In all the configurations it is possible for the wall to comprise at least one core, to which, for example on the two outside faces, cover layers are applied, which then form the side faces. It is also possible for a wall to consist, or be put together, of two partial walls, the partial walls comprising at least one core each. The two partial walls may each provide half of the wall thickness, or they can provide any other desired proportions, e.g. 20% and 80%. Accordingly, each of the partial walls may comprise at least one core or partial core. Preferably, one cover layer each is applied on the outside surfaces. In the case of a wall consisting of two partial walls, the takeup space may be configured in one partial wall only, or alternately it may be configured in both partial walls (in equal or different proportions).

The method according to the invention of manufacturing a furniture component comprises the following steps. First, at least one wall having at least one takeup space in the wall is provided. Aperture sections may be comprised in, or formed on, the wall, so that the takeup space on the wall is outwardly open on at least two of the front faces of the wall. Thereafter, a set of fittings for guiding a movable furniture element is disposed in the takeup space, so that during transfer of the set of fittings from a first position to a second position, the set of fittings enters, or moves along, the aperture sections in the at least two front faces.

In an alternative to subsequently configuring a takeup space in the wall, said space may, at least partially or entirely, already be provided in an original wall component. The wall component may for example be manufactured with the takeup space (or a substantial part of the takeup space) in a primary forming process, such as casting, compression molding, foaming process, etc. Finishing is possible. Such finishing process may be mechanical, by machining or chipless, chemical and/or physical.

The wall is preferably formed of at least one core. It is possible to incorporate the aperture sections for example by machining such as milling. Chemical or other processes are likewise possible.

Preferably, lateral cover layers are applied on the core and/or the set of fittings. This provides for a uniform optical surface of the wall. The set of fittings is virtually hidden in the wall interior, so as to provide an esthetically attractive and functional furniture component. By way of providing aperture sections at least on two front faces of the wall, the furniture component may provide for particularly large access for example to the interior of a furniture carcass.

The invention provides for an advantageous furniture component. It is possible to cover the side faces of the wall by continuous cover layers, so as to obtain an appealing appearance.

The wall may be configured as a composite component in which the set of fittings is accommodated. The front faces may be provided with edge strips to ensure an overall uniform surface.

Further advantages and features of the present invention can be taken from the exemplary embodiments which will be discussed below with reference to the enclosed figures.

The figures show in:

FIG. 1 a schematic perspective view of a first embodiment of a furniture component according to the invention;

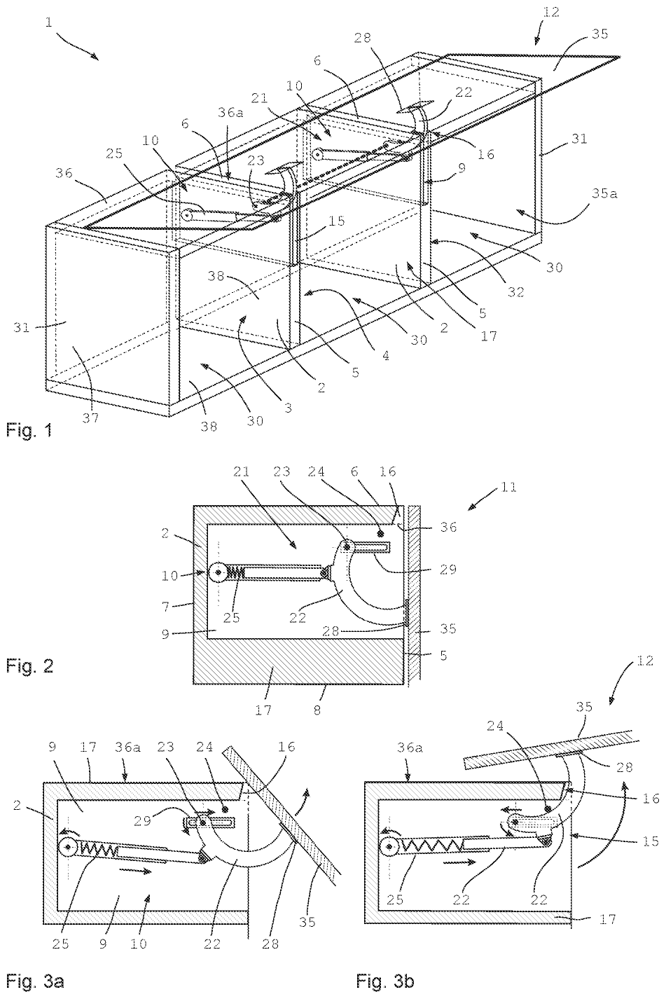

FIG. 2 a simplistic cross section of another furniture component according to the invention in a first position;

FIG. 3a a simplistic cross section of the furniture component according to FIG. 2 in an intermediate position;

FIG. 3b a simplistic cross section of the furniture component according to FIG. 2 in a second position;

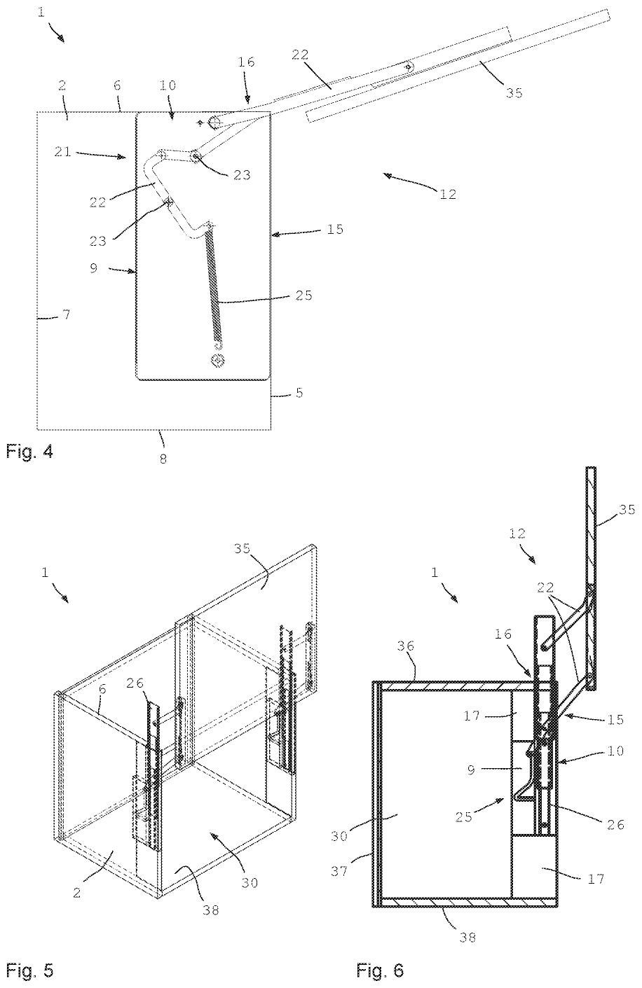

FIG. 4 a simplistic, cross-sectional illustration of another exemplary embodiment of the furniture component;

FIG. 5 a perspective illustration of still another exemplary embodiment of a furniture component according to the invention;

FIG. 6 a sectional side view of the furniture component according to FIG. 5;

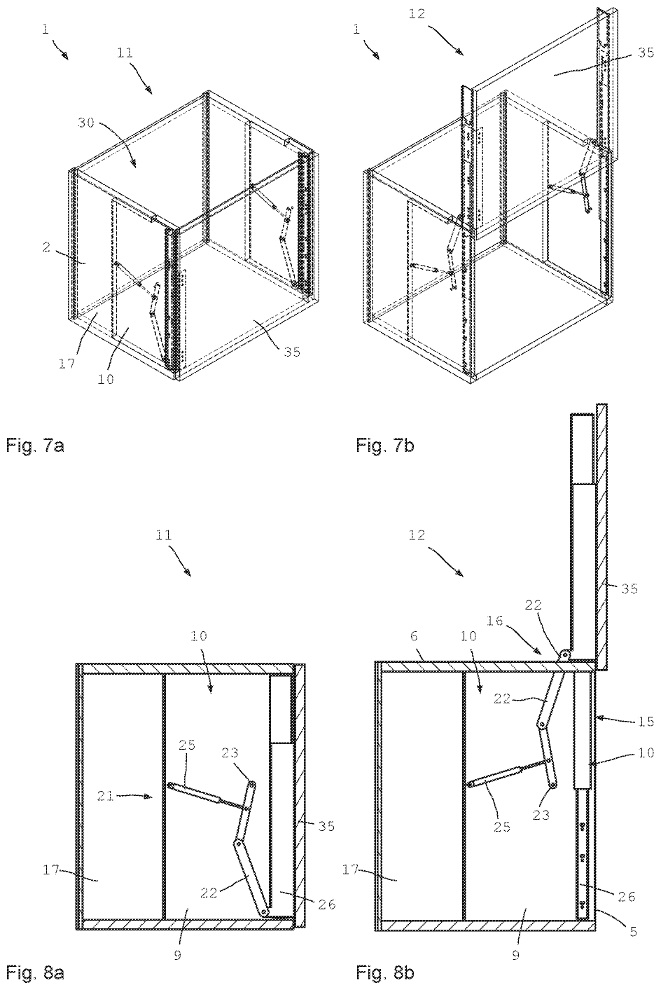

FIG. 7a a perspective view of another exemplary embodiment of a furniture component according to the invention;

FIG. 7b the furniture component according to FIG. 7a in the second position;

FIG. 8a a cross section of the furniture component according to FIG. 7a;

FIG. 8b a cross section of the furniture component in FIG. 7b in the second position;

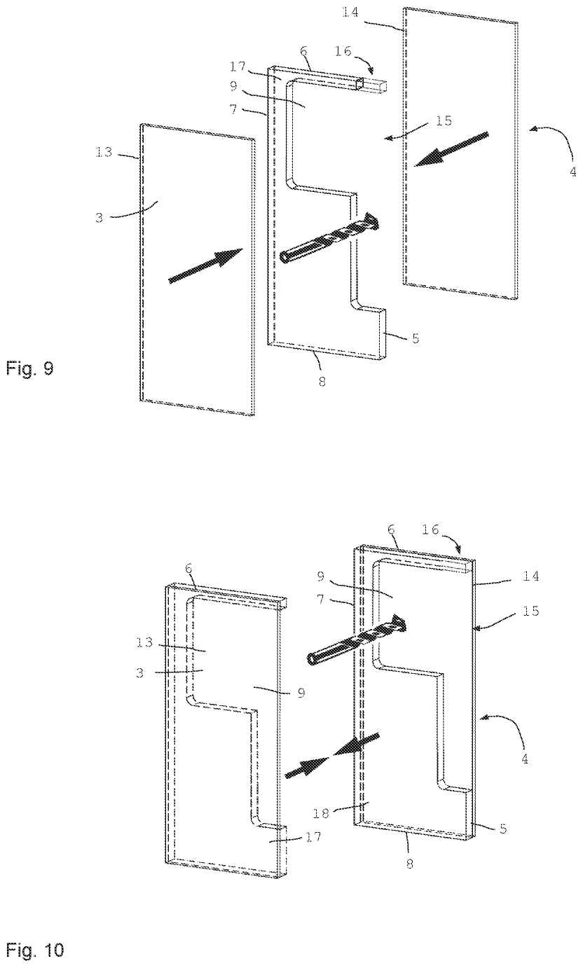

FIG. 9 a schematic illustration of manufacturing a wall of a furniture component according to the invention;

FIG. 10 another method of manufacturing a wall of a furniture component according to the invention;

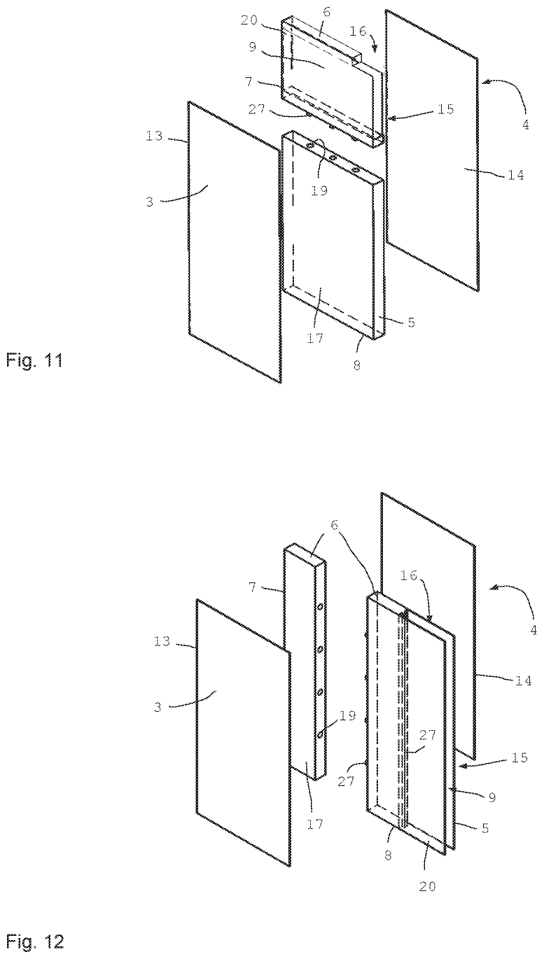

FIGS. 11 and 12, further manufacturing processes for furniture components according to the invention;

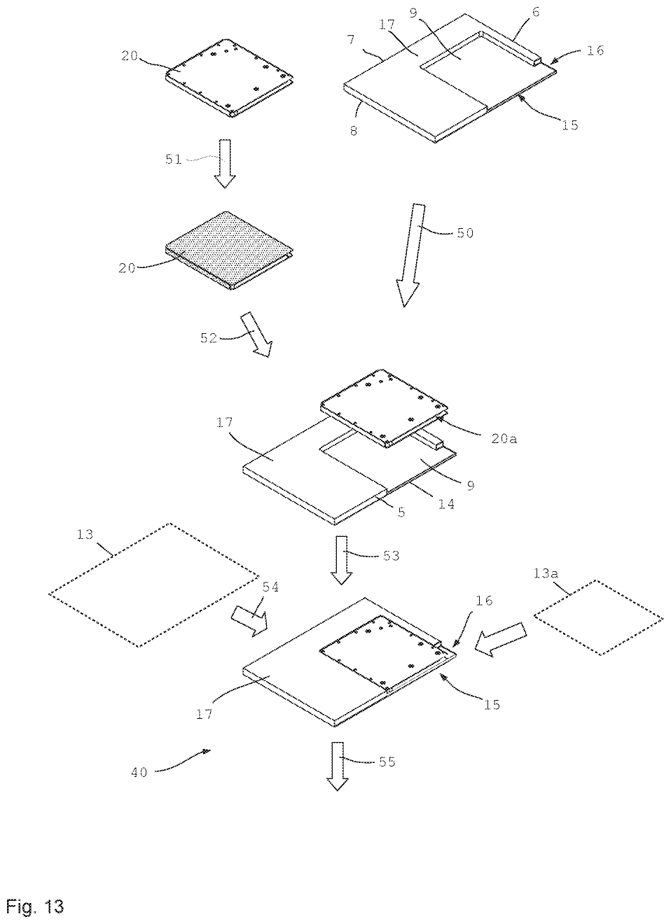

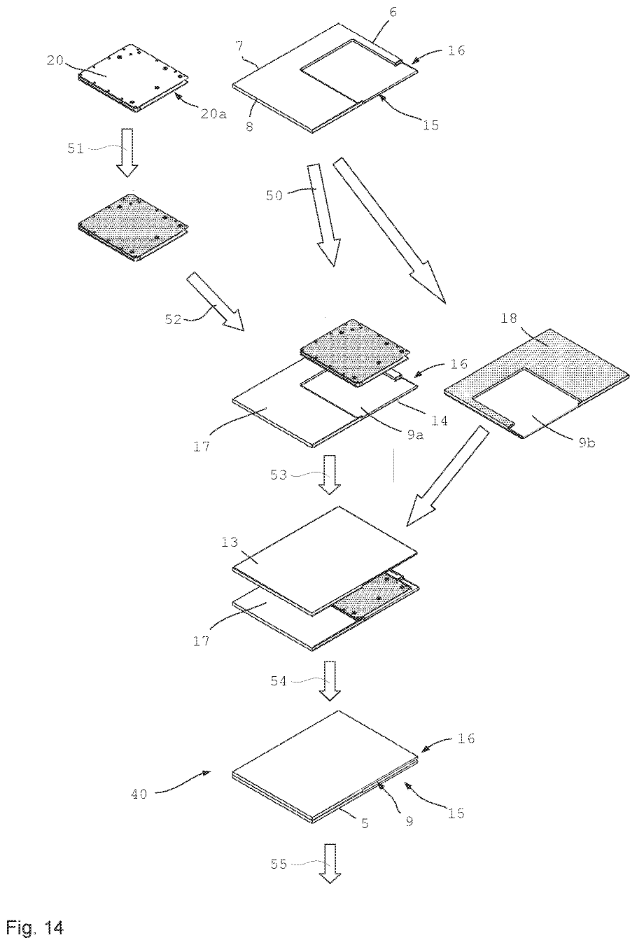

FIG. 13 a flowchart of a manufacturing process of a furniture component according to the invention; and

FIG. 14 a flowchart of another manufacturing process of a furniture component according to the invention.

With reference to FIG. 1, a first exemplary embodiment of a furniture component 1 according to the invention is discussed. FIG. 1 shows a simplistic illustration of a furniture component 1 according to the invention in the open position 12. The furniture component 1 provides three takeup compartments 30, which can be closed by one shared, movable furniture element 35, presently configured as a flap door.

Various figures of the exemplary embodiments, including FIG. 1, show some parts of the furniture component 1 partially transparent, respectively show invisible edges in broken lines to facilitate understanding. In reality, the parts are as a rule nontransparent.

The furniture component 1 comprises two lateral walls 31, presently two partition walls 32, each configured as a functional wall or wall 2 and comprising a takeup space 9 each, accommodating one set of fittings 10 each.

Each of the partition walls 32 is provided with a left-hand side face 3 and an opposite, right-hand side face 4, which are presently completely fitted with the cover layers 13 or 14 (cf. e.g. FIGS. 9 and 10). This provides for a uniform surface. The cover layers 13 and 14 provide a decorative surface which preferably matches the other surfaces of the furniture component 1. All the visible surfaces of the furniture component 1 (other than the aperture sections 15, 16 and visible fitting components) are preferably configured at least optically identical. It is also possible to provide different surface areas, for reasons of design.

FIG. 1 shows a schematic illustration of the furniture component 1. While the side walls 31 are configured solid, the partition walls 32 each show a takeup space 9 with a set of fittings 10 accommodated therein. The set of fittings 10 may comprise a plurality of similar and/or different fitting components 20-29 and others. FIG. 1 exemplarily shows a gearing 21 with an energy storage 25 and a lever arm 22.

The front end of the lever arm 22 is provided with an attachment member 28, to which the flap door is attached, as a movable furniture element 35.

The walls 2, presently configured as partition walls 32, of the furniture component 1 are provided with four front surfaces 5, 6, 7 and 8, the front surface 5 forming the access side 35a. On the access side 35a, the front face 5 is configured with an aperture section 15, which in the exemplary embodiment according to FIG. 1 extends across almost half the height of the wall 2. The aperture section 15 extends over the entire height of the takeup space 9. This enables exchanging a set of fittings 10 without demounting the wall 2.

The top face of the furniture component 1 is followed by an aperture section 16 on the front face 6. The aperture sections 15 and 16 form one shared through hole, so as to enable the lever arm 22 to pivot outwardly from the aperture section 15 on the front face 5 as far as into, and back out of, the aperture section 16 on the front face 6.

On the top face of the furniture component 1, a top board 36 closes the takeup compartments 30. The rear wall 37 closes the takeup compartments 30 to the rear, and the takeup compartments 30 are bordered downwardly by the bottom board 38. Intermediate boards may be provided.

The fact that the aperture sections 15 and 16 extend across adjacent front faces 5 and 6 of the walls 2, enables a wide pivot angle for the lever arm 22, which does not need to be designed particularly long. This achieves high stability, since the lever arms can be configured shorter than they are in the prior art.

Also, no extensive kinematic gearing is required for pivoting the flap door into the space above the top board.

Moreover, full access to the interior of the furniture component 1 can be provided. Neither are there interfering fitting components on the inside surfaces of the intermediate or side walls, nor is the interior covered by the movable furniture element 35 in the top region of the takeup compartments 30. Moreover, no movable or stationary fitting components are attached even outside of the furniture component 1.

This enables a construction of a furniture component 1 which provides a simple and minimalistic overall appearance. The fitting components disappear inside the wall, which does not need to be thicker than conventional walls of furniture components or in particular kitchen furniture from the prior art. A uniform surface is enabled, and the core 17 of the wall 2 and the pertaining cores of the other walls may be manufactured cost-effectively and flexibly of standard materials for furniture and in particular of standard materials for kitchen furniture.

The core may for example consist of a chipboard or a medium or high density fiberboard (MDF or HDF).

The opening motion of the flap door or the movable furniture element 35 (from the closed position not shown in FIG. 1) to the open position 12 illustrated in FIG. 1 causes the lever 22 to pivot about the fixed rotating point 23. A stopper 24 may be provided to protect the top board 36 and the aperture section 16 or its edges from damage.

Providing the interconnected aperture sections 15, 16 allows to realize full opening of the takeup compartments 30 using a short lever arm 22. The aperture section 16 shown is even very short. The length of the aperture section 16 is less than the width of the lever arm along the front face 6. Although the aperture section 16 is considerably shorter than the aperture section 15, maximum opening is achieved. The ratio of the length of the aperture section 15 to the length of the aperture section 16 on the longitudinal face 36a is larger than 4:1 and in particular larger than 8:1 or larger than 10:1.

Absent the aperture section 16, the lever arm 22 would have to be configured considerably longer, which would cause the movable furniture element 35 to pivot still further upwardly in the opened state, so as to restrict access to users. Moreover, the set of fittings 10 with the flap door or the furniture component 1 attached thereto would be more unstable on the whole.

FIG. 2 and FIGS. 3a and 3b show a modified exemplary embodiment, FIG. 2 showing the closed position 11, and FIG. 3a, a partially opened position, and FIG. 3b, the (fully opened) open position 12.

The furniture component 1 comprises a wall 2 shown in section, as a functional wall, and a top board 36, which is visible only in the region of the aperture section 16. On the access side 35a, the front face 5 is provided with a movable flap door or a movable furniture element 35. In the closed position in FIG. 2, the takeup compartment 30 is behind the movable furniture element 35.

The wall 2 comprises at least one core 17, on which a takeup space 9 is configured. The takeup space 9 accommodates a set of fittings 10 comprising multiple fitting components, such as lever arms 22, rotating points 23, a stopper 24, an energy storage 25, and attachment members 28.

The flap door is attached to the outwardly end of the lever arm 22 by means of attachment members 28. The lever arm 22 in turn is rotatably disposed in the rotating point 23. A stopper 24 restricts the motion. Unlike in the exemplary embodiment according to FIG. 1, the rotating point 23 is not disposed stationary, but is linearly displaceable along the link guide which is presently configured as a linear guide 29. Alternately, the lever arm 22 may be movably received in a link guide or pivot bearing extending straight and/or curved. This enables an advantageous construction which also saves mounting space, providing a large opening cross section although the lever arm 22 is short, while concurrently enabling a controlled sequence of motions of the movable furniture element.

FIG. 3a shows an intermediate position between the closed position 11 and the open position 12 illustrated in FIG. 3b. In FIG. 3a one can see that the rotating point 23 of the lever arm 22 has moved away from the lefthand limit stop of the linear guide or link guide 29, to achieve the desired opening motion where maximum opening is achieved with short lever arms 22.

A top strip of the core 17 of the wall 2 forms the top boundary on the top front face 6. In the region of the takeup compartment 30 the top board 36 shown in broken lines forms the boundary, which has no cutout in the region of the aperture section 16.

FIG. 4 shows a simplistic cross section of another exemplary embodiment, the furniture component 1 being illustrated in the second position 12, the open position. Once again the wall 2 is illustrated in section so as to show the takeup space 9 which comprises, toward the front face 5 and the front face 6, aperture sections 15 and 16 blending into one another. This enables the lever arm 22 to emerge outwardly through the aperture section 15, and to continuously pivot as far as into the aperture section 16. In this way, virtually full access to the takeup compartment 30 of the furniture component 1 is achieved. The set of fittings 10 is accommodated in the takeup space 9, comprising at least one gearing 21 with lever arms 22, which are accommodated for rotation around rotating points 23. An energy storage 25 allows a counterweight for the movable furniture element 35 in the open position 12. The bottom region of the movable furniture element 35 may comprise a grip, not shown, disposed on the outside.

The FIGS. 5 and 6 illustrate another exemplary embodiment of a furniture component 1 according to the invention, wherein FIG. 5 shows a perspective view and FIG. 6, a lateral cross section.

The furniture component 1 again comprises two walls 2, each including a takeup space 9 accommodating a set of fittings 10 each. At least one core 17 is disposed in the wall 2 adjacent to the takeup space 9 and fixedly connected with the set of fittings 10. Alternately, two or more cores may exist, for example to both sides of the set of fittings 10.

In this place, a combined pivoting and linear motion is provided for, wherein preferably the pivoting motion occurs first, and thereafter the movable furniture element 35 is pushed upwardly by way of a linear motion.

The gearing 21 comprises lever arms 22, which during transfer from the closed position 11 to the open position 12 firstly emerge forwardly out of the aperture section 15. In the upwardly linear motion at least one of the lever arms 22 also emerges outwardly through the aperture section 16 on the front face 6.

The linear motion takes place via a track system 26, which presently comprises three telescopic tracks. In particular provided is a plate track or sidewall track or a carcass track, accommodated on the wall 2. Upwardly follow, a central track and a front panel track, wherein the front panel track is fixedly connected with the movable furniture element 35. The energy storage 25 acts on the front panel track, so that the open position 12 can be maintained automatically. It is possible for the track system 26 to only comprise two, or more than three, telescoping tracks.

FIGS. 7a and 7b illustrate a perspective view of another exemplary embodiment of a furniture component 1 according to the invention. The pertaining cross sections are illustrated in the FIGS. 8a and 8b.

The exemplary embodiment according to the FIGS. 7 and 8 provides for an all linear motion for transferring the movable furniture element 35 from the closed position 11 (FIG. 7a and FIG. 8a) to the open position 12 (FIG. 7b and FIG. 8b).

The functional walls or walls 2 comprise a takeup space 9 each, bordering a core 17. The takeup space 9 accommodates a set of fittings 10, a track system 26 being provided for transferring the movable furniture element 35 to the open position 12. The gearing 21 comprises at least one energy storage 25, a track system 26, and lever arms 22, the lever arms 22 being pivotally disposed around fixed and movable rotating points 23.

When opening the flap door respectively the movable furniture element 35, the tracks of the track system move inside the aperture section 15. It is also possible for the lever arm 22 to enter the aperture section 15 from the interior. At any rate, in the opening motion the lever arm 22 enters the aperture section 16, so that in this exemplary embodiment, fitting components again enter into, or pass through, both of the aperture sections 15, 16.

The finished furniture component 1 comprises cover layers 13, 14 on the side faces 3 and 4 of the walls 2 (see FIGS. 9 and 10). This ensures a uniform and optically appealing surface. The set of fittings 10 is invisible from the side of the furniture component 1.

FIG. 9 shows a schematic illustration of manufacturing a wall 2, wherein a core 17 is machined for example by means of a milling cutter or similar chip-removing tool, or by way of another process, so as to incorporate a takeup space 9. After machining, the core 17 provides a front face 5 with the aperture section 15, a front face 6 with the aperture section 16 and further, presently closed, front faces 7 and 8.

After incorporating the takeup space 9, the cover layers 13, 14 may be applied on both sides of the core 17, so as to generally produce a wall 2 comprising a takeup space 9, which includes the aperture sections 15 and 16 toward two adjacent front faces 5, 6. The aperture sections 15 and 16 blend into one another.

FIG. 10 shows another manufacturing process using two cores 17, 18, wherein only part of the wall thickness is removed from each of the cores, for example by chip-removing machining. This provides the cores 17, 18, each providing half the takeup volume for one set of fittings 10. Thereafter the two cores 17, 18 are interconnected, for example glue-bonded or screwed to one another, or by another process. The wall 2 so created comprises the takeup space 9 for a set of fittings 10. The takeup space is provided with the aperture sections 15 and 16, after the corresponding aperture section 16 has been made by the milling cutter or other suitable tool on the front face 6, as can be seen in FIG. 9 or on the right in FIG. 10. The aperture section 16 may be formed in both the cores 17, 18, or only by removal of the region in broken lines on the core 18, depending on whether the opening created on one side is sufficient.

FIG. 11 illustrates the schematic wall structure of a wall 2 of a furniture component 1, wherein presently, a core 17 and a hollow profile 20 are used. The hollow profile 20 may be configured as a housing and may be provided with fixed and continuous side walls. At any rate, a takeup space 9 is configured or defined in the hollow profile 20, which serves to receive a complete fitting or a number of fitting components of the set of fittings 10. The hollow profile 20 and the core 17 are preferably provided with installation profiles 27 and 19, which are preferably configured in a form-fit to one another, enabling a form-fit connection of the hollow profile 20 with the core 17. Thereafter the cover layers 13 and 14 are applied, preferably on the entire surface of the set of fittings 10 or the hollow profile 20 and the core 17, so that a uniform appearance of the side faces 3 and 4 ensues. The front faces 5, 6 are provided with adjacent aperture sections which blend into one another.

Accordingly, FIG. 12 shows a variant whose core is not disposed vertically but horizontally, adjacent a hollow profile 20. Installation profiles 27 on the hollow profile 20 and installation profiles 19 on the core 17 achieve a form-fit connection of the core 17 with the hollow profile 20. The hollow profile 20 is configured with a takeup space 9 for receiving fitting components of the set of fittings 10. Optionally, an entire fitting hardware can be inserted and fixed therein.

The hollow profile 20 is for example manufactured as an extruded profile of aluminum or an aluminum alloy, and may be provided with another installation profile 27 between the lateral walls. The takeup space shows aperture sections 15, 16 toward the front faces 5, 6.

FIG. 13 shows a flowchart for the manufacturing process of a furniture component 1. Firstly, a plate-like material is provided as the core 17 in step 50. A suitable recess 9 is incorporated in the core 17, or a core is e.g. directly provided with a takeup space 9. A core 17 with a takeup space 9 may be manufactured e.g. by mechanical remachining from a material that is e.g. plate-like. Alternately, a core 17 with a recess may be manufactured directly by way of a primary forming process and may be remachined e.g. by mechanical, electric, chemical, and/or physical etc. processes. The recess is intended to later accommodate a hollow profile 20 or a set of fittings 10.

In step 51, a functional component, presently the set of fittings 10 or a hollow profile 20, is provided in parallel. For example a fitting may be pushed into a suitable hollow profile 20. Or, the pertaining fitting components are incorporated in the hollow profile 20, so as to obtain a full set of fittings 10.

Thereafter in step 52, the side faces of the hollow profile 20 and/or the surface of the takeup space 9 are sprinkled for example with an adhesive. In step 53 follows inserting and positioning the fittings or the hollow profile 20 in the recesses on the core 17.

As can be seen in the bottom part of FIG. 13, on the front face 5 an aperture section 15 remains, and on the front face 6, an aperture section 16, which blend into one another. This allows a lever arm 22 to emerge out of the interior of the hollow profile 20, it can both emerge outwardly through the aperture section 15, and can enter in the aperture section 16 during the further pivoting.

If desired, in step 54 a cover layer 13 may be applied on the system consisting of the core 17 and the set of fittings 10, or one cover layer 13a only, matching the size of the set of fittings 10 or of the housing 20 may be applied on the set of fittings 10, so that cover layers 13, 14 are applied both from above and below, thus providing a substantially uniform surface. Finally the entire system or the composite component 40 of the wall 2 may be press-bonded in step 55.

FIG. 14 shows a flowchart of a process flow where the furniture component 1 is manufactured by using two cores or core portions 17, 18, into which one recess each with the sub-spaces 9a and 9b is incorporated, each corresponding to approximately half the volume of the takeup space 9.

Firstly, e.g. the plate-like material is provided as a core 17 in step 50, and at least one recess is incorporated. It is also possible to directly manufacture the core 17 with a recess or a takeup space 9, by a suitable primary forming process. Accordingly the functional component, presently the hollow profile 20 or the set of fittings 10, is provided in step 51. The hollow profile 20 comprises the hollow profile interior 20a to accommodate the fitting components. The outer surfaces of the hollow profile 20 are sprinkled with an adhesive in step 52. Accordingly, the surfaces on the recesses of the cores 17, 18 may also be sprinkled with an adhesive.

The two sides or cores 17, 18 are aligned in step 53, and the set of fittings 10 is positioned on the first core.

Thereafter in step 54, the second side of the set of fittings 10 is sprinkled, and the second core 18 is aligned and placed. Cover layers 13, 14 are preferably applied on the cores 17, 18 from the outside, so that again, a uniform surface ensues. Optionally cover layers 13, 14 may be applied on the cores 17, 18 prior to manufacturing the recesses.

Finally, in step 55, after press-bonding the entire system, a composite component 40 is obtained, which forms the wall 2 and comprises aperture sections 15 and 16 in adjacent front faces 5 and 6, and in this case already comprises the set of fittings 10 or at least one hollow profile 20.

On the whole the present invention provides an advantageous furniture component and an advantageous method of manufacturing the same, wherein the fullest possible access to the interior of a piece of furniture is enabled, and wherein nearly 100% free access to, and utilization of, the interior is provided. The fact that two adjacent aperture sections which blend into one another are configured in two adjacent front faces, allows to implement novel opening concepts. The lever arms may be configured short, so as to ensure increased stability. Also, some lever mechanism components, as they would be required for more complex gearing kinematics, may be omitted. Optionally, the lever arms may be configured thinner, so as to leave a larger wall thickness on the wall 2, or to allow a thinner wall thickness of the walls 2.

The openings in two front faces allow to configure shorter lever arms, which in a system having one aperture section only, would require considerably longer lever arms for achieving the same flap door position respectively position of the movable furniture element 35.

The core may alternately consist of lightweight materials.

The invention allows to utilize more than one front surface of the furniture component and thus enables better access to the interior. The set of fittings 10 is entirely hidden inside the wall in the closed position 11. In the open position 12, the lever arms 22 emerge outwardly of the aperture sections 15 and 16 of the takeup space 9 between the side faces 3 and 4 of the wall 2, so as to enable full utilization of the interior of a furniture component 1.

The drive for moving the movable furniture element may be manually actuated by the operator, with energy storage supporting and/or optimizing the operating forces and providing for stable end and/or intermediate positions.

Alternately (supplementarily or selectively), driving means energy-loaded e.g. by electric energy may be used. In this case, signal-controlled actuators may be provided, and for example sensors may be provided for querying specific positions or operating states, with the aid of which the motions are controlled.

List of reference numerals:

| | |
|---|---|
| 1 | furniture component |
| 2 | wall |
| 3 | side face |
| 4 | side face |
| 5 | front face |
| 6 | front face |
| 7 | front face |
| 8 | front face, bottom face |
| 9 | takeup space |
| 9a | sub-space |
| 9b | sub-space |
| 10 | set of fittings |
| 11 | position, closed position |
| 12 | position, open position |
| 13 | cover layer |
| 13a | cover layer |
| 14 | cover layer |
| 15 | aperture section |
| 16 | aperture section |
| 17 | core |
| 18 | core |
| 19 | installation profile |
| 20 | hollow profile, housing |
| 20a | interior |
| 21 | gearing |
| 22 | lever arm |
| 23 | rotating point |
| 24 | stopper |
| 25 | energy storage |
| 26 | track system |
| 27 | installation profile |
| 28 | attachment member |
| 29 | linear guide |
| 30 | takeup compartment |
| 31 | sidewall |
| 32 | partition wall |
| 35 | movable furniture element, flap door, lid, door |
| 35a | access side |
| 36 | top board |
| 36a | longitudinal face, top face |
| 37 | rear wall |
| 38 | bottom board |
| 40 | composite component |
| 50-55 | process steps |

1. A furniture component, comprising: a wall with at least two opposite side faces and a multitude of front faces;
wherein on the wall between the side faces, at least one takeup space is configured, in which a set of fittings for guiding a movable furniture element is received;
wherein the set of fittings comprises a multitude of fitting components and can be transferred to at least two positions;
the takeup space comprises, in at least two front faces of the wall, aperture sections where the takeup space is opened outwardly;
and that the set of fittings is configured and set up such that during transfer of the set of fittings from the first position to the second position, the set of fittings moves at least in the two aperture sections in the at least two front faces.

2. The furniture component according to claim 1, wherein the aperture sections are configured in front faces adjacent to one another.

3. The furniture component according to claim 2, wherein the aperture sections are configured adjacent to one another and blending into one another.

4. The furniture component according to claim 1, wherein two aperture sections are configured in front faces spaced apart from, or opposite, one another.

5. The furniture component according to claim 1, wherein the takeup space accommodates a hollow profile as a fitting component, on which further fitting components are accommodated in at least one position.

6. The furniture component according to claim 1, wherein at least one fitting component is taken from a group of fitting components comprising, gearings, lever arms, rotating points, stoppers, damper components, energy storage devices, actuators, sensors, coil springs, pressure accumulators, telescopic track systems, sliding tracks such as plate tracks, central tracks, front panel tracks, installation profiles, attachment members and link guides.

7. The furniture component according to claim 1, wherein at least one lever arm is configured as a fitting component, which in transfer from the first position to the second position passes through both the aperture sections.

8. The furniture component according to claim 1, comprising at least one movable furniture element that is connected with the set of fittings.

9. The furniture component according to claim 1, wherein the first position is a closed position and the second position, an intermediate position or open position.

10. The furniture component according to claim 9, wherein the fitting components are disposed in the closed position within a wall volume opened up by the front faces and the side faces, other than attachment members for attaching the movable furniture element to the set of fittings.

11. The furniture component according to claim 1, wherein the movable furniture element is disposed in the closed position on an access side, by way of the movable furniture element separating a takeup compartment which in the open position is accessible from the access side.

12. The furniture component according to claim 11, wherein one of the aperture sections is configured on the front face on the access side, and the other of the aperture sections, on a front face on a longitudinal face extending transverse thereto.

13. The furniture component according to claim 12, wherein the aperture section on the access side is longer than the aperture section on the longitudinal face.

14. The furniture component according to claim 13, wherein the aperture section on the access side is at least twice the length or at least three times the length of the aperture section on the longitudinal face.

15. The furniture component according to claim 1, wherein the proportion of the length of the aperture section to the length of the front face on the access side is more than one third, and/or wherein the proportion of the length of the aperture sections to the length of the front face on the longitudinal face is less than one third.

16. The furniture component according to claim 1, wherein the set of fittings is configured and set up so that during transfer of the set of fittings from the first position to the second position, at least one of the fitting components moves at least in a first aperture section, and that during transfer of the set of fittings from the first position to the second position, one of the fitting components moves at least in the second aperture section.

17. The furniture component according to claim 1, wherein the set of fittings is configured and set up such that during transfer of the set of fittings from the first position to the second position, at least one of the fitting components moves in the two aperture sections, and passes outwardly from inside, through at least one of the two aperture sections.

18. The furniture component according to claim 1, wherein the wall comprises at least one core, and wherein at least one core is connected with the set of fittings.

19. The furniture component according to claim 18, wherein the wall comprises at least two cores, wherein two cores are provided with one recess each, and wherein at least two cores are interconnected.

20. The furniture component according to claim 1, wherein the set of fittings and/or the core is connected with at least one of the cover layers.

21. The furniture component according to claim 1, wherein at least one of the side faces or both of the side faces are configured on a continuous cover layer.

22. The furniture component according to claim 1, which provides at least one takeup compartment, which takeup compartment is bordered by at least one board and/or at least one top board and/or at least one bottom board and at least one wall, and which can be at least partially closed by the movable furniture element.

23. A method of manufacturing a furniture component, comprising the following steps:
providing at least one wall with at least one takeup space with aperture sections, so that the takeup space is opened outwardly on at least two front faces of the wall;
disposing a set of fittings for guiding a movable furniture element in the takeup space, so that during transfer of the set of fittings from a first position to a second position, the set of fittings enters the aperture sections in the at least two front faces.

24. The method according to claim 23, wherein the wall is formed of at least one core.

25. The method according claim 23, wherein lateral cover layers are applied onto the core and/or the set of fittings.
